(19) United States
(12) Patent Application Publication
(10) Pub. No.: US 2024/0336442 A1
(43) Pub. Date: Oct. 10, 2024

(54) SCREW CONVEYOR WITH RADIAL EJECTION GEOMETRY

(71) Applicant: ITT Bornemann GmbH, Obernkirchen (DE)

(72) Inventors: Jannik Meyer, Hohnhorst (DE); Mostafa Mahmoodzada, Burgdorf (DE); Eike Steffen Korte, Petershagen (DE); Jens Dralle, Hespe (DE); David Johannes Blatt, Meerbeck (DE)

(21) Appl. No.: 18/131,837

(22) Filed: Apr. 6, 2023

(51) Int. Cl. B65G 33/10; B65G 33/26

(52) U.S. Cl. CPC B65G 33/10; B65G 33/265

(57) ABSTRACT

A conveying system including a conveying chamber and a conveying screw. The conveying chamber includes an inlet opening and an outlet opening. The conveying screw is positioned in the conveying chamber and has a screw shaft with an axis of rotation and a screw thread positioned radially on the outside of the screw shaft. The conveying screw also includes one or more ejector elements radially on the outside of the screw shaft proximate the rear end of the screw thread. Each ejector elements includes an ejector surface that has a curvature against the direction of the rotation of the screw shaft. The ejector elements cover at least a portion of the outlet opening in the axial direction. The outlet opening is positioned radially outside of the ejector element.

### CROSS REFERENCE TO RELATED APPLICATION

Any and all applications for which a foreign or domestic priority claim is identified in the Application Data Sheet of the present application are hereby incorporated by reference in their entireties under 37 CFR 1.57.

### BACKGROUND

### Technical Field

The present disclosure relates to a conveying system, such as a screw conveyor with radial ejection geometry.

### Brief Description of Related Art

Conveying systems may include a conveying screw. Conveying screws rotate about an axis of rotation to convey a product along a conveying direction that is substantially parallel to the axis of rotation. Conveying systems are also frequently equipped with several conveying screws to increase the conveying capacity of the conveying system.

### SUMMARY

In some aspects, the techniques described herein relate to a conveying system including: a conveying chamber including an inlet opening and an outlet opening; and a conveying screw positioned in the conveying chamber including: a screw shaft with an axis of rotation and a screw thread positioned radially on an outside of the screw shaft, and an ejector element positioned radially on the outside of the screw shaft next to a rear end of the screw thread, wherein the ejector element includes an ejector surface that at least partially extends over the outlet opening in an axial direction, and wherein the outlet opening is positioned radially outside of the ejector element.

In some aspects, the techniques described herein relate to a conveying system, wherein the ejector surface has a curvature against a direction of rotation of the screw shaft in a radially outer region.

In some aspects, the techniques described herein relate to a conveying system, wherein a minimum radial distance between an outer wall of the conveying chamber and the ejector element during a rotation of the screw shaft about the axis of rotation is less than 10 cm.

In some aspects, the techniques described herein relate to a conveying system, wherein a minimum radial distance between an outer wall of the conveying chamber and the ejector element during a rotation of the screw shaft about the axis of rotation is less than 1 mm.

In some aspects, the techniques described herein relate to a conveying system, wherein a plurality of ejector elements is positioned radially on the outside of the screw shaft next to the rear end of the screw thread, each of the ejector elements of the plurality of ejector elements forming an ejector surface.

In some aspects, the techniques described herein relate to a conveying system, wherein each of the ejector elements of the plurality of ejector elements are equally spaced in a circumferential direction on the screw shaft.

In some aspects, the techniques described herein relate to a conveying system, wherein an outer wall of the conveying chamber is formed to at least partially correspond to a shape of the conveying screw.

In some aspects, the techniques described herein relate to a conveying system, wherein the conveying system includes a plurality of conveying screws.

In some aspects, the techniques described herein relate to a conveying system, wherein the plurality of conveying screws are synchronized.

In some aspects, the techniques described herein relate to a conveying system, wherein the outlet opening is positioned on a bottom side of the conveying chamber.

In some aspects, the techniques described herein relate to a conveying system, wherein an axial length of the outlet opening is equal to or greater than an axial length of the ejector element.

In some aspects, the techniques described herein relate to a conveying system, wherein a rear end of the outlet opening is positioned behind a rear end of the ejector element in a conveying direction.

In some aspects, the techniques described herein relate to a conveying system, wherein the outlet opening is positioned immediately next to the rear end of screw thread.

In some aspects, the techniques described herein relate to a conveying system, wherein the outlet opening ends with a rear wall of the conveying chamber.

In some aspects, the techniques described herein relate to a conveying screw including: a screw shaft with an axis of rotation and a screw thread positioned radially on an outside of the screw shaft; and an ejector element positioned radially on the outside of the screw shaft next to a rear end of the screw thread, wherein the ejector element includes an ejector surface that at least partially extends over an outlet opening in an axial direction.

In some aspects, the techniques described herein relate to a conveying screw, wherein the ejector surface has a curvature against a direction of rotation of the screw shaft in a radially outer region.

In some aspects, the techniques described herein relate to a conveying screw, wherein a plurality of ejector elements is positioned radially on the outside of the screw shaft next to the rear end of the screw thread, each of the ejector elements of the plurality of ejector elements forming an ejector surface.

In some aspects, the techniques described herein relate to a conveying screw, wherein the plurality of ejector elements is equally spaced in a circumferential direction on the screw shaft.

In some aspects, the techniques described herein relate to a conveying screw, wherein a pitch of the screw thread becomes smaller towards the rear end of the screw thread.

In some aspects, the techniques described herein relate to a conveying system including: a conveying chamber including an inlet opening and an outlet opening; and a conveying screw positioned in the conveying chamber including: a screw shaft with an axis of rotation and a screw thread positioned radially on an outside of the screw shaft, and a plurality of ejector elements positioned radially on the outside of the screw shaft next to a rear end of the screw thread, wherein each of the ejector elements of the plurality of ejector elements includes an ejector surface that has a curvature against a direction of rotation of the screw shaft in a radially outer region, and that at least partially extends over the outlet opening in an axial direction, and wherein the outlet opening is positioned radially outside of the plurality of ejector elements.

### BRIEF DESCRIPTION OF THE DRAWINGS

The drawing includes the following Figures, which are not necessarily drawn to scale:

FIG. 1 illustrates a perspective view of an example conveying screw for a conveying system.

FIG. 2 illustrates a sectional view of an example conveying system.

FIG. 3 illustrates a partially cut top view of an example partially assembled conveying system.

FIG. 4 illustrates a perspective view of an example conveying system.

FIGS. 5A and 5B illustrate a side view of an example conveying screw for a conveying system.

FIG. 6 illustrates a side view of an example conveying screw with a curved ejector surface.

The drawing includes examples of possible implementations; and the scope of the invention is not intended to be limited to the implementations shown therein. For example, the scope of the invention is intended to include, and embodiments are envisioned using, other implementations besides, or in addition to, that shown in the drawing, which may be configured within the spirit of the underlying invention disclosed in the present application as a whole.

### DETAILED DESCRIPTION

Some embodiments described herein relate to a conveying system comprising a conveying chamber having an inlet opening and an outlet opening, at least a conveying screw arranged in the conveying chamber and having a screw shaft with an axis of rotation and at least a screw thread arranged radially on the outside of the screw shaft. Some embodiments also relate to a conveying screw.

In some embodiments, the inlet opening is arranged radially on the conveying system, while the outlet opening may be arranged either axially or radially. With an axially arranged outlet opening, the conveyed product exits the conveying chamber in the conveying direction. The outlet opening may be arranged on the rear face of the conveying chamber. A radially arranged outlet opening may be arranged on a bottom side of the conveying system, so that the ejection of the conveyed product perpendicular to the conveying direction radially outward from the conveying chamber is supported by gravity. There are a variety of factors that may influence the ejection performance, such as the viscosity of the conveyed product, the stickiness of the conveyed product, and the shape of the outlet opening. An unfavorable combination of these influencing parameters may result in a backlog of conveyed product, which in turn leads to a reduced conveying capacity. Advantageously, the conveying system described herein reduces unfavorable combinations and avoids the disadvantages in the prior art.

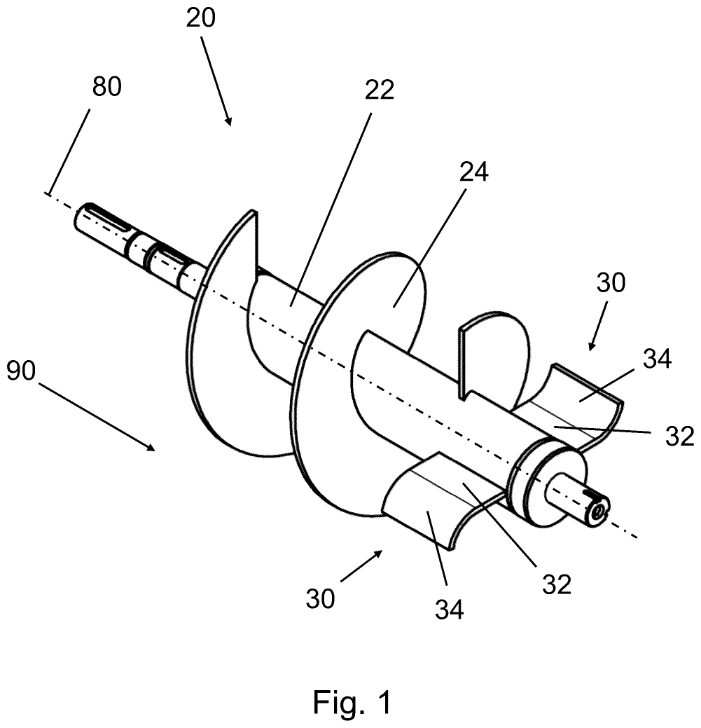

FIG. 1 shows a perspective view of an example conveying screw 20. The conveying screw 20 has a screw shaft 22 which extends along its axis of rotation 80. A screw thread 24 is arranged radially on the outside of the screw shaft 22. In the embodiment shown, the screw shaft 22 and the screw thread 24 are made in one piece or materially fixed to each other, for example by a weld. It is also possible to connect the screw thread 24 to the screw shaft 22 using one or more positive and/or non-positive locking devices so that a torque transmission may be possible. Positive locking devices may use physical barriers or interlocking mechanisms to ensure that the screw thread 24 stays securely attached to the screw shaft 22 during operation. Examples of positive locking devices include cotter pins, locking nuts or bolts, interlocking joints, internal gearing, feather keys etc. Examples of non-positive locking devices include friction fits, magnetic connections, standard nuts and bolts, etc. When the screw shaft 22 is rotated about the axis of rotation of the screw shaft 22, a conveyed product that is not shown may be conveyed through the screw thread 24 in a conveying direction 90.

Two ejector elements 30 are arranged on the outside of the screw shaft 22 behind the screw thread 24 in the conveying direction 90 that point radially outwards. The ejector elements 30 each form an ejector surface 32 which, in the embodiment shown, has a curvature 34 in a radially outer region counter to the direction of rotation of the screw shaft 22. The ejector elements 30 may also, or alternatively, be designed to form flat ejector surfaces 32. In some embodiments, instead of a continuous curvature 34, the ejector surfaces 32 may also, or alternatively, be formed by a plurality of inclined flat sections arranged one behind the other in the direction of rotation.

The ejector elements 30 may be equally spaced in the circumferential direction on the screw shaft 22. In the embodiment shown, the ejector elements 30 are arranged diametrically opposite each other on the screw shaft 22. In the embodiment shown, the ejector elements 30 are integrally formed with the screw shaft 22. Alternatively or additionally, ejector elements 30 may be materially, positively and/or non-positively connected to the screw shaft 22.

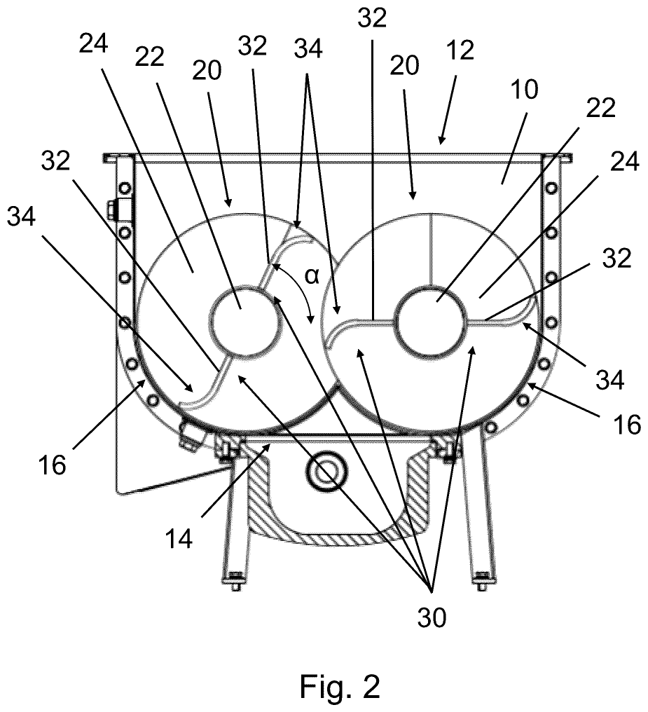

FIG. 2 shows a sectional view of an example conveying system with a sectional direction transverse to the conveying direction. The conveying system may include a conveying chamber 10 with an inlet opening 12 arranged at the top and an outlet opening 14 arranged at the bottom. The inlet opening 12 may alternatively or additionally be arranged laterally on the conveying chamber 10 or on a front face of the conveying chamber 10.

In some embodiments, two conveying screws 20 are arranged side by side in the conveying chamber 10. The conveying screws 20 may each have a screw shaft 22 with an axis of rotation and a screw thread 24 arranged radially outside on the screw shaft 22. In addition, or alternatively, two ejector elements 30 may be arranged diametrically opposite each other radially on the outside of each screw shaft 22 in the conveying direction 90 behind the screw thread 24 (e.g., after the rear end of the screw thread 24). In some embodiments, the ejector elements 30 each form an ejector surface 32 and, in a radially outer region, have a curvature 34 counter to the direction of rotation of the respective screw shaft 22. The direction of rotation of the left-hand conveying screw 20 may be counterclockwise. Accordingly, the ejector elements 30 of the left-hand conveying screw 20 may have curvatures 34 radially on the outside which are curved in a clockwise direction. In some embodiments, the direction of rotation of the right-hand conveying screw 20 is clockwise. Therefore, the ejector elements 30 of the right-hand conveying screw 20 may have curvatures 34 radially on the outside which are curved in a counterclockwise direction. In some embodiments, the axes of rotation of the two conveying screw 20 are parallel to each other. In some embodiments, the radial distance between the axes of rotation of the two conveying screws 20 may be less than the sum of the radii of the screw threads 24 of the two conveying screws 20 so that the screw threads 24 overlap (as shown in FIG. 2).

In order to avoid a collision of the conveying screws 20, the two conveying screws 20 may be arranged twisted to each other by an angle of twist a. The angle of twist a between the right ejector element 30 of the left conveying screw 20 and the right ejector element 30 of the right conveying screw 20 may be about 65°. Any other angle of twist a at which it may be ensured that the conveying screws 20, and in particular the screw threads 24 and the ejector elements 30 of the conveying screws 20, do not collide with each other when the screw shafts 22 of the two conveying screws 20 are rotated about the respective axis of rotation at the same angular velocity in terms of magnitude may be used (e.g., 10°, 20°, 30°, 60°, 90°, more than 90°, or any angle in-between). The conveying screws 20 may be synchronized, for example by means of a belt drive that is not shown, a gearbox or two drive units which are synchronously controlled by a control unit.

In some embodiments, the conveying chamber 10 is trough-like configured and comprises two outer walls 16, which may be configured to correspond to the conveying screws 20. The outer walls 16 may be configured to correspond to the conveying screws 20 and follow the course of the conveying screws 20 and, in particular, the radius of the screw thread 24 in the area below the respective axis of rotation. In some embodiments, when the screw shafts 22 rotate about their respective axis of rotation, the gap between the screw threads 24 and the respective outer wall 16 and the gap between the ejector elements 30 and the respective outer wall 16 are preferably as small as possible (e.g., 0.1 mm, 1 mm, 2 mm, 10 mm, 100 mm etc.) to maximize the conveying and ejection action of the conveying system.

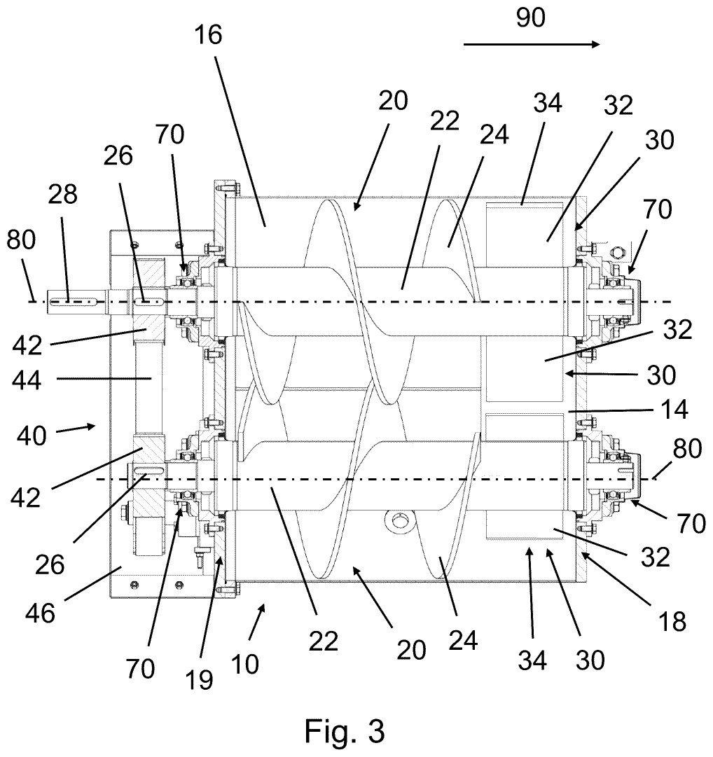

FIG. 3 shows a partially cut top view of an example partially assembled conveying system. In some embodiments, the conveying system has a conveying chamber 10 with an inlet opening (not shown) and an outlet opening 14. The outlet opening 14 may close off in the conveying direction with a rear face 18 of the conveying chamber 10. The conveying screws 20 may be arranged in the conveying chamber 10, each having a screw shaft 22 with an axis of rotation 80 and a screw thread 24. In some embodiments, radially outside the conveying screws 20 is arranged an outer wall 16 of the conveying chamber 10, which may be formed to correspond to the conveying screws 20. In the conveying direction 90 behind the screw thread 24, ejector elements 30 may be arranged diametrically opposite each other on the screw shaft 22. In some embodiments, the ejector elements 30 each form an ejector surface 32, which has a curvature 34 radially on the outside.

The screw shafts 22 are supported by ball bearings 70. Alternatively or in addition, a bearing arrangement may be provided via plain bearings and/or other rolling bearings. The ball bearings 70 may be arranged on the outside of the conveying chamber 10. Alternatively or additionally thereto, the ball bearings 70 may be arranged in the conveying chamber 10 or at another location of the conveying system.

In some embodiments, a belt drive 40 is arranged on the conveying chamber 10 in front of the conveying chamber 10 in the conveying direction 90. Alternatively or additionally, a belt drive 40 may be arranged behind the conveying chamber 10 in the conveying direction 90. The belt drive 40 may include a housing 46 and two toothed belt disks 42 arranged therein, each of which is arranged on a screw shaft 22 via a keyway 26. Alternatively or in addition to being arranged via keyways, the toothed belt disks 42 may be arranged on the screw shaft 22 by means of a transition or interference fit, dovetail groove connection, screws, multi-tooth connections and/or other fastening means. A toothed belt 44 may be arranged on the outside of the toothed belt disks 42.

In some embodiments, the belt drive 40 synchronizes the two screw shafts 22 so that their angular velocity is equal in amount. At the same time, the belt drive 40 may ensure that the two screw shafts 22 rotate in opposite directions about their axis of rotation 80. As an alternative or addition to a belt drive 40, synchronization of the screw shafts 22 may be achieved by a gearbox or by two separated drive units that are synchronously controlled by a control unit. The screw shafts 22 of the upper conveying screw 20 may include a drive keyway 28 in front of the keyway 26 in conveying direction 90. In some embodiments, the drive keyway 28 serves to arrange the screw shaft 22 of the upper conveying screw 20 on an output shaft of a drive unit (not shown). A drive unit may alternatively or additionally be arranged behind, beside, above and/or below the conveying chamber 10 in the conveying direction 90 and may be or may include an electric motor, which in turn may be coupled directly or via a gear unit to the drive screw shaft 22.

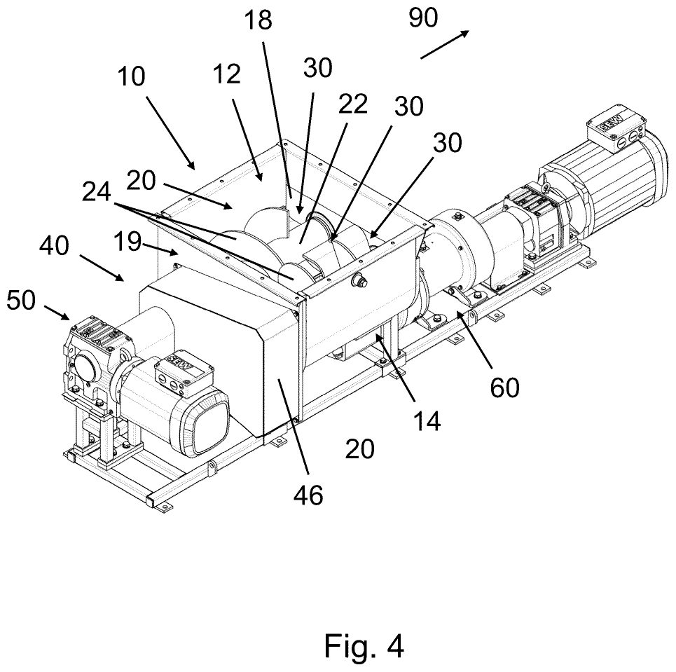

FIG. 4 shows a perspective view of an example conveying system. The conveying system may include a conveying chamber 10 with an inlet opening 12 at the top and an outlet opening 14 at the bottom. In some embodiments, the outlet opening 14 closes off in the conveying direction 90 with an rear wall 18 of the conveying chamber 10. Two conveying screws 20 with a screw shaft 22 and a screw thread 24 arranged radially on the outside thereof may be arranged within the conveying chamber 10. The screw threads 24 may have a common conveying direction 90. In the conveying direction 90 behind the screw thread 24, ejector elements 30 may be arranged on the screw shafts 22. In front of the conveying chamber 10 in conveying direction 90, a belt drive 40 with a housing 46 may be arranged for synchronizing the magnitude of the angular velocities of the screw shafts 22. In some embodiments, a drive unit 50 in the form of an electric motor with gearbox, which drives a screw shaft 22, may be arranged in front of the belt drive 40 in conveying direction 90. A screw pump 60, in which the conveyed product may be further conveyed, may be arranged behind the conveying chamber 10 in conveying direction 90.

In some embodiments, the conveying system increases the conveying capacity and reliability of the system by including a conveying chamber 10 having an inlet opening 12 and an outlet opening 14, and at least one conveying screw 20 arranged in the conveying chamber 10 and having a screw shaft 22 with an axis of rotation 80 and at least a screw thread 24 arranged radially on the outside of the screw shaft 22. Alternatively, or in addition, radially on the outside of the screw shaft 22 in the conveying direction 90 behind the screw thread 24 at least one ejector element 30 may be arranged which may form an ejector surface 32 and at least partially covers the outlet opening 14 in the axial direction. In some embodiments, the outlet opening 14 may be arranged radially outside of the ejector element 30. Advantageously, the radial ejection of the conveyed product into the outlet opening 14 may be actively supported by the ejector element 30. In this way, a backlog of conveyed product may be avoided, so that even conveyed products with a high viscosity and/or a high stickiness may be conveyed. Thus, the conveying system described herein ensures a continuous conveying flow of product.

In some embodiments, the normal vector of the ejector surface 32 and the conveying direction 90 are perpendicular to each other, whereby the conveyed product may be forced and moved outward. To drive the screw shaft 22, it may be coupled to a drive unit 50 for rotating the screw shaft 22 about the axis of rotation 80. In some embodiments, the drive unit 50 is designed as an electric motor, which may be coupled either directly or via a gearbox to the screw shaft 22 in order to set it in rotation about the axis of rotation 80.

In some embodiments, the screw shaft 22, the screw thread 24, and/or the ejector element 30 are embodied as a single piece. Alternatively or additionally, the screw shaft 22, the screw thread 24, and/or the ejector element 30 can be embodied as separate components. In some embodiments, the screw thread 24 and/or the ejector element 40 are fixed to the screw shaft 22 so that it is possible to arrange different screw threads 24 with different pitches on a screw shaft 22 and to exchange them if necessary. Likewise, in some embodiments, it may be provided that the ejector element 30 or the ejector elements 30 are attached to the screw shaft 22 in an interchangeable manner, for example in order to be able to adapt to different conveyed products or to be able to replace the ejector element 30 in the event of wear. In some embodiments, the screw thread 24 and/or the ejector element 30 are frictionally, positively and/or materially connected to the screw shaft 22.

The inlet opening 12 can be arranged radially and/or axially on the conveying chamber 10. In addition to an inlet opening 12 oriented purely in the radial direction or an inlet opening 12 oriented purely in the axial direction, i.e. arranged on a front face 19, the inlet opening 12 can also, or alternatively, have a radial component and an axial component. For example, the inlet opening 12 can be oriented obliquely to the conveying direction 90. The inlet opening 12 may serve to feed a conveyed product into the conveying chamber 10. In some embodiments, the outlet opening 14 is arranged behind the screw thread 24 in the conveying direction 90. The outlet opening 14 may serve for discharging a conveyed product from the conveying chamber 10. The conveying chamber 10 can be open on one side. In some embodiments, the open side forms the inlet opening 12.

In some embodiments, the screw thread 24 has a constant pitch. The pitch is the distance between two adjacent thread turns and, for a constant pitch, remains unchanged over the entire length of the screw thread. Alternatively, the pitch of the screw thread 24 may not be constant along the entire length of the screw thread 24. For example, the pitch may change continuously along the length of the screw thread 24 or the screw thread 24 may have sections with a constant pitch and a changing pitch. In some embodiments, the pitch of the screw thread 24 becomes smaller in the conveying direction 90.

In some embodiments, the ejector surface 32 advantageously has a curvature 34 against the direction of rotation of the screw shaft 22 in a radially outer region. The curvature 34 facilitates the conveyance of the conveyed product in the radial direction towards the outlet opening 14 and may prevent an unwanted accumulation of the conveyed product in the conveying chamber 10 in the area of the screw shaft 22. When the ejection surface 32 is curved against the predetermined direction of rotation of the screw shaft 22, the conveyed product may be moved outward and away from the axis of rotation 80, thus preventing deposits. In some embodiments, the direction of rotation may be a predetermined direction of rotation.

In some embodiments, the curvature 34 is constant, increasing radially outward, and/or decreasing radially outward. In some embodiments, the ejector element 30 is curved over its entire radial extent. For example, the curvature 34 may preferably extend completely over the radial extent of the ejector element 30. Alternatively, the ejector surface 32 can comprise a flat partial surface in a radially inner region. In some embodiments, curvature 34 extending from the base or attachment of the ejector element 30 on the screw shaft 22 generates a force component acting radially outward. The force may be generated over the entire ejector surface 32 and an accumulation of the conveyed product on the screw shaft 22 may be effectively avoided or at least reduced. The curvature 34 of the ejector element 30 can additionally, or alternatively, provide conveyance in the conveying direction 90, wherein for this purpose the curvature 34 along the longitudinal extension may be provided with a pitch in the same direction as the pitch of the screw thread, for example, with a substantially greater pitch. In some embodiments, the radial extension and/or the axial extension (e.g., axial length) of the ejector element 30 is constant.

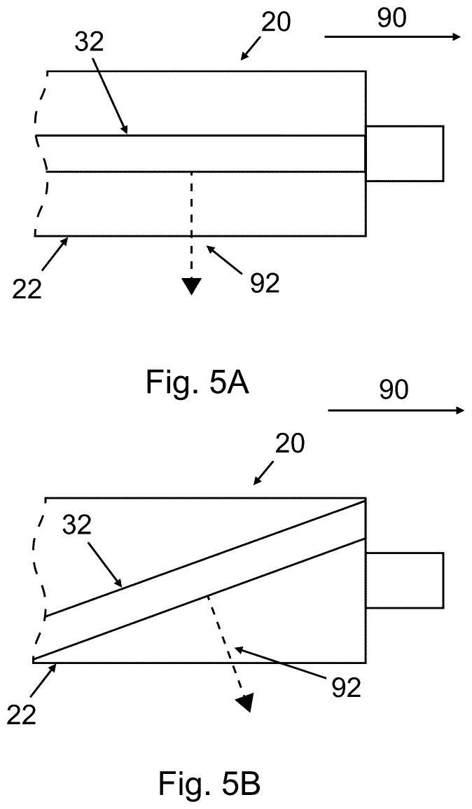

FIGS. 5A and 5B illustrate a side view of an example conveying screw 20 for a conveying system. In some embodiments, at least one normal vector of the ejector surface 32 is arranged at an ejection angle 92 between 50° and 130°, for example between 70° and 110°, or between 80° and 100° to the conveying direction 90. For example, in FIG. 5A the ejection angle 92 is perpendicular to the conveying direction 90. As another example, in FIG. 5B the ejection angle 92 is 70° to the conveying direction 90. The ejection angle 92 may be modified to eject the conveyed product more efficiently and safely.

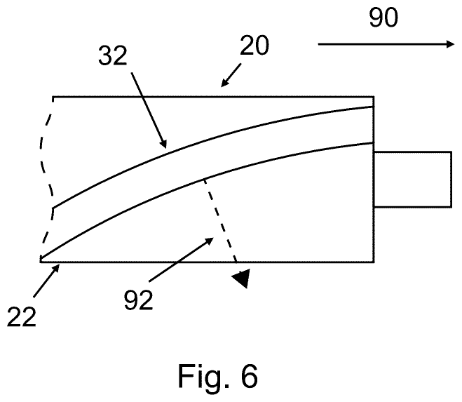

FIG. 6 illustrates a side view of an example conveying screw 20 with a curved ejector surface 32. In some embodiments, at least part of the ejector surface 32 can be curved about an axis that is perpendicular to the conveying direction 90, as shown in FIG. 6. Alternatively, or in addition, at least part of the ejector surface 32 can be curved about an axis that is parallel to the conveying direction 90, as shown in FIGS. 1 and 2. Thus the ejector surface 32 may have several local normal vectors, each of which spans an ejection angle 92 with the conveying direction 90. For example, at least 50%, 75%, 90%, more than 90%, or any percentage in between of the normal vectors of the ejector surface may be arranged at an ejection angle between 50° and 130°, for example between 70° and 110°, or 80° and 100° to the conveying direction 90. It can be advantageous if the ejection angle between at least one normal vector of the ejector surface 32 and the conveying direction 90 is smaller than 90°, so that the ejector element 30 supports the conveyance of the conveyed product in the conveying direction 90. In some embodiments, at least one normal vector of the ejector surface 32 is arranged at an ejection angle of 90° with respect to the conveying direction 90. For example, at least one normal vector of the ejector surface 32 and the conveying direction 90 may be perpendicular to each other. For example, at least 50%, 75%, 90%, more than 90%, or any percentage in between of the normal vectors may be arranged at an ejection angle of 90° to the conveying direction 90. In some embodiments, the normal vector of a plane partial surface of the ejector surface 32 is arranged at an ejection angle of between 50° and 130°, for example between 70° and 110°, or between 80° and 100° to the conveying direction 90. In some embodiments, the normal vector of a flat partial surface of the ejector surface 32 may be arranged at an ejection angle of 90° to the conveying direction 90.

In some embodiments, the minimum radial distance between an outer wall 16 of the conveying chamber 10 and the ejector element 30 during rotation of the screw shaft 22 about the axis of rotation 80 is at most 10 cm, 1 cm, 1 mm, 0.1 mm, less than 0.1 mm, or any distance in between. In some embodiments, the minimum radial distance between an outer wall 16 of the conveying chamber 10 and the screw thread 24 during rotation of the screw shaft 22 about the axis of rotation 80 is at most 10 cm, 1 cm, 1 mm, 0.1 mm, less than 0.1 mm, or any distance in between. In some embodiments, a plurality of ejector elements 30 are arranged radially on the outside of the screw shaft 22 in the conveying direction 90 behind the screw thread 24, each forming an ejector surface 32.

In some embodiments, the ejector elements 30 are arranged diametrically opposite and/or equally spaced in the circumferential direction on the screw shaft 22. If, for example, three ejector elements 30 are arranged behind the screw thread 24 in the conveying direction 90 and transport the conveyed product radially outward, these may be arranged at a distance of 120° from each other on the screw shaft 22 in order to achieve uniform force distribution and uniform conveyance of the product.

In some embodiments, the outer wall 16 of the conveying chamber 10 is formed at least partially corresponding to the conveying screw 20. For example, the conveying chamber 10 may be formed as a cylinder in which the conveying screw 20 may be arranged in the form of a cylinder, the conveying chamber 10 being provided or arranged in a housing, for example multi-part housing, in order to facilitate assembly. In some embodiments, the diameter of the screw thread 24 is constant along the axial extension of the screw thread 24. Alternatively, the screw thread 24 can have a diameter that increases and/or decreases in the conveying direction 90.

In some embodiments, the conveying system comprises a plurality of conveying screws 20. In some embodiments, the radial distance between the axes of rotation of two adjacent conveying screws 20 is less than the sum of the radii of the screw threads 24 of the adjacent conveying screws 20. In order to reduce the manufacturing effort, the screw threads 24 of the conveying screws 20 may have the same diameter. Particularly in the case of interlocking screw threads 24, the screw threads 24 of the conveying screws 20 may have the same pitch, in which case the directions of rotation of adjacent conveying screws 20 about their respective axes of rotation may be opposite. In some embodiments, the directions of rotation of adjacent conveying screws 20 about their respective axis of rotation are opposite. The screw threads 24 of the conveying screws 20 may have a common conveying direction 90.

In some embodiments, adjacent conveying screws 20 are twisted relative to each other by an angle of twist a so that the screw threads 24 of the adjacent conveying screws 20 do not collide when the screw shafts 22 rotate about their respective axis of rotation 80 at the same angular velocity and the ejector elements 30 of the two conveying screws 20 do not collide when the screw shafts 22 rotate about their respective axis of rotation 80 at the same angular velocity. The angle of twist a is the angle between a main plane of a first conveying screw 20 and the main plane of another conveying screw 20 adjacent to the first conveying screw 20, one of the main planes being parallel to the plane spanned by the axes of rotation 80 of the adjacent conveying screws 20. The angle between the main planes of two adjacent conveying screws 20 may change, for example due to the opposite directions of rotation of the screw shafts 22 of two adjacent conveying screws 20 during the rotation of the screw shafts 22 of two adjacent conveying screws 20 about their respective axis of rotation 80.

In some embodiments, the main planes may be parallel to each other at a point in time during the rotation of the screw shafts 22 of two adjacent conveying screw 20 about their respective axis of rotation 80. There may also, or alternatively, be two or more conveying screws 20 adjacent to the first conveying screw 20. The main plane may be spanned by the axis of rotation 80 of the conveying screw 20 and the geometric center of gravity of the contact surface between the screw shaft 22 and an ejector element 30. If a conveying screw 20 has a plurality of ejector elements 30, different angles of twist a may occur depending on which ejector element 30 the main plane is spanned by. Alternatively, the main plane may be spanned by the axis of rotation 80 of the conveying screw 20 and an end point of the screw thread 24 in the conveying direction 90. If the screw thread 24 has a plurality of end points in the conveying direction 90, the radially outermost end point may be used to span the main plane to the axis of rotation 80 of the conveying screw 20.

In some embodiments, the conveying screws 20 are synchronized. For example, the screw shafts 22 of the conveying screws 20 may have the same angular velocity at the same time. This synchronization may be realized via a mechanical coupling, for example a belt drive, a gearbox, and/or via several drive units which are controlled in a synchronized manner by a control unit. In some embodiments, the outlet opening 14 is arranged at a bottom side of the conveying chamber 10. By arranging the outlet opening 14 on a bottom side of the conveying chamber 10, the discharge of the conveyed product from the conveying chamber 10 through the outlet opening 14 may be supported by gravity. In some embodiments, a projected area of the outlet opening 14 is substantially rectangular.

In some embodiments, the axial extension of the outlet opening 14 is at least the axial extension of the ejector element 30. Preferably, the outlet opening 14 completely covers the ejector element 30 in the axial direction. The outlet opening 14 may extend to the rear face 18 of the conveying chamber 10 in the conveying direction 90, as may the ejection element 30, so that no unwanted accumulations of the conveyed product are created at the end of the conveying chamber 10. Alternatively, the outlet opening 14 may extend in axial extension beyond the rear end of the ejection element 30, or the ejection element 30 may extend beyond the outlet opening 14 in the conveying direction 90 in the conveying chamber 10.

In some embodiments, a rear end of the outlet opening 14 in the conveying direction 90 is arranged behind a rear end of the ejector element 30 in the conveying direction 90. The rear is respectively the end that is arranged at the rear in the conveying direction 90. The front end is respectively the end that is arranged at the front in the conveying direction 90. In some embodiments, the outlet opening 14 is arranged immediately behind the screw thread 24 in the conveying direction 90. For example, the distance between the rear end of the screw thread 24 and the front end of the outlet opening 14 may be at most 2 cm, 3 cm, 4 cm, 5 cm, 6 cm, more than 6 cm, or any distance in between. In some embodiments, the outlet opening 14 ends with a rear face 18 of the conveying chamber 10 in the conveying direction 90.

It should be understood that, unless stated otherwise herein, any of the features, characteristics, alternatives or modifications described regarding a particular embodiment herein may also be applied, used, or incorporated with any other embodiment described herein. Also, the drawing herein is not drawn to scale.

Although the invention has been described and illustrated with respect to exemplary embodiments thereof, the foregoing and various other additions and omissions may be made therein and thereto without departing from the spirit and scope of the present invention.

What is claimed:

1. A conveying system comprising:
a conveying chamber comprising an inlet opening and an outlet opening; and
a conveying screw positioned in the conveying chamber comprising:
a screw shaft with an axis of rotation and a screw thread positioned radially on an outside of the screw shaft, and
an ejector element positioned radially on the outside of the screw shaft next to a rear end of the screw thread, wherein the ejector element comprises an ejector surface that at least partially extends over the outlet opening in an axial direction, and wherein the outlet opening is positioned radially outside of the ejector element.

2. The conveying system of claim 1, wherein the ejector surface has a curvature against a direction of rotation of the screw shaft in a radially outer region.

3. The conveying system of claim 1, wherein a minimum radial distance between an outer wall of the conveying chamber and the ejector element during a rotation of the screw shaft about the axis of rotation is less than 10 cm.

4. The conveying system of claim 1, wherein a minimum radial distance between an outer wall of the conveying chamber and the ejector element during a rotation of the screw shaft about the axis of rotation is less than 1 mm.

5. The conveying system of claim 1, wherein a plurality of ejector elements is positioned radially on the outside of the screw shaft next to the rear end of the screw thread, each of the ejector elements of the plurality of ejector elements forming an ejector surface.

6. The conveying system of claim 5, wherein each of the ejector elements of the plurality of ejector elements are equally spaced in a circumferential direction on the screw shaft.

7. The conveying system of claim 1, wherein an outer wall of the conveying chamber is formed to at least partially correspond to a shape of the conveying screw.

8. The conveying system of claim 1, wherein the conveying system comprises a plurality of conveying screws.

9. The conveying system of claim 8, wherein the plurality of conveying screws are synchronized.

10. The conveying system of claim 1, wherein the outlet opening is positioned on a bottom side of the conveying chamber.

11. The conveying system of claim 1, wherein an axial length of the outlet opening is equal to or greater than an axial length of the ejector element.

12. The conveying system of claim 1, wherein a rear end of the outlet opening is positioned behind a rear end of the ejector element in a conveying direction.

13. The conveying system of claim 1, wherein the outlet opening is positioned immediately next to the rear end of screw thread.

14. The conveying system of claim 1, wherein the outlet opening ends with a rear wall of the conveying chamber.

15. A conveying screw comprising:
a screw shaft with an axis of rotation and a screw thread positioned radially on an outside of the screw shaft; and
an ejector element positioned radially on the outside of the screw shaft next to a rear end of the screw thread, wherein the ejector element comprises an ejector surface that at least partially extends over an outlet opening in an axial direction.

16. The conveying screw of claim 15, wherein the ejector surface has a curvature against a direction of rotation of the screw shaft in a radially outer region.

17. The conveying screw of claim 15, wherein a plurality of ejector elements is positioned radially on the outside of the screw shaft next to the rear end of the screw thread, each of the ejector elements of the plurality of ejector elements forming an ejector surface.

18. The conveying screw of claim 17, wherein each of the ejector elements of the plurality of ejector elements are equally spaced in a circumferential direction on the screw shaft.

19. The conveying screw of claim 15, wherein a pitch of the screw thread becomes smaller towards the rear end of the screw thread.

20. A conveying system comprising:
a conveying chamber comprising an inlet opening and an outlet opening; and
a conveying screw positioned in the conveying chamber comprising:
a screw shaft with an axis of rotation and a screw thread positioned radially on an outside of the screw shaft, and
a plurality of ejector elements positioned radially on the outside of the screw shaft next to a rear end of the screw thread, wherein each of the ejector elements of the plurality of ejector elements comprises an ejector surface that has a curvature against a direction of rotation of the screw shaft in a radially outer region, and that at least partially extends over the outlet opening in an axial direction, and wherein the outlet opening is positioned radially outside of the plurality of ejector elements.
